(19) United States
(12) Patent Application Publication
(10) Pub. No.: US 2010/0279909 A1
(43) Pub. Date: Nov. 4, 2010

(54) Skin Cleansing Formulations With Silica Particle Sensory Indicator

(75) Inventors: Christine A. Boyke, Somerset, NJ (US); Marian N. Holerca, Somerset, NJ (US); Mahmoud Hassan, Somerset, NJ (US); Nadia Soliman, East Brunswick, NJ (US); Donna Hartnett, Belle Mead, NJ (US); Rabab Ahmed, Somerset, NJ (US)

Correspondence Address: COLGATE-PALMOLIVE COMPANY, 909 RIVER ROAD, PISCATAWAY, NJ, 08855, US

(73) Assignee: COLGATE-PALMOLIVE COMPANY, New York, NY (US)

(21) Appl. No.: 12/159,940

(22) PCT Filed: Jul. 1, 2008
(86) PCT No.: PCT/US08/68903

§ 371 Date: Jul. 2, 2008

(51) Int. Cl. C11D 3/20; A61Q 19/10

(52) U.S. Cl. 510/138

(57) ABSTRACT

A composition comprising surfactant, structuring agent, glycerin, and a silica particle that disintegrates during use. Also, a method comprising applying the composition to hands; rubbing the hands together until a sensory change detectable to the hands is perceived; and rinsing the hands with water. The composition provides a signal to a user to continue washing for a sufficient time. This silica particle disintegrates to a size that is not felt by a user, and this indicates to the user that there has been a sufficient time for washing.

### BACKGROUND OF THE INVENTION

“Skin hygiene”, particularly of the hands, is a primary mechanism for reducing contact and transmission of infectious agents. According to the CDC, despite the public awareness of the need to wash hands, the recommended methods of washing hands are not followed. The public does not wash frequently enough nor for sufficient time. It should also be noted, however, that too much time washing (scrubbing) could damage the skin. The Association for Professionals in Infections Control and Epidemiology (“APIC”) recommends washing hands by wetting hands with running water, applying hand-washing agent, thoroughly distributing it over hands, and vigorously rubbing hands for 10-15 seconds while covering all surfaces of the hands and fingers. The APIC recommends an antimicrobial soap or detergent or alcohol-based rub wash for 10-15 seconds to remove or kill transient micro-organisms, for example, in nursing and food preparation applications. The APIC further recommends an antimicrobial soap or detergent with brushing for at least 120 seconds for surgical applications. It is noteworthy to distinguish the difference between “killing” and “removing” germs. Killing germs can be accomplished by the use of specific ingredients that have deadly effect on the life cycle of the germs. Examples of ingredients that kill germs are Triclosan, PCMX (p-chloro-m-xylenol), Quats, surfactants, etc. An example of a formulation designed to kill germs is a sanitizer gel, which is applied to the hands for the purpose of killing germs, but does not remove the germs. The use of a soap, however, leads to the removal of germs, combined with a mild killing action. In this case, the length of time spent washing the hands can have a great impact on eradication of microbes.

Getting the timing right, however, is an issue. For children it is recommended that they sing the alphabet song once or happy birthday twice in order to wash their hands for 15 seconds. For adults there is no good indicator of when the time is up for efficient hand washing. Thus, there remains a need for a cleaning formulation that will provide an indication to the user how long he has washed his hands to indicate that the cleansing is effective and/or to comply with the health protocols.

### BRIEF SUMMARY OF THE INVENTION

A composition comprising:

a) surfactant.
b) structuring agent,
c) glycerin, and
d) a silica particle that disintegrates during use.

Also a method comprising:

a) applying the composition to hands;
b) rubbing the hands together until a sensory change detectable to the hands is perceived; and
c) rinsing the hands with water.

### DETAILED DESCRIPTION OF THE INVENTION

Unless otherwise specified, all percentages and amounts expressed herein and elsewhere in the specification should be understood to refer to percentages by weight. The amounts given are based on the active weight of the material.

As used throughout, ranges are used as shorthand for describing each and every value that is within the range. Any value within the range can be selected as the terminus of the range.

In addition, all references cited herein are hereby incorporated by reference in their entireties. In the event of a conflict in a definition in the present disclosure and that of a cited reference, the present disclosure controls.

The present invention is related to skin cleansing formulations with a silica particle sensory indicator that indicates appropriate usage time in response to an application of a mechanical force that disintegrates the silica particle over time. This invention allows for easy and precise recognition of the appropriate time for washing. The properties of the silica particle may be adjusted to provide the desired end point in time.

Silica particles that can be used in the present invention are available from INEOS Silicas Ltd., and they are described in U.S. Pat. No. 6,165,510 and United States Patent Application Publication No. 2003/0044442. Examples of these particles are available as PC50S (average particle size of 250 μm), CBT60 (average particle size of 200 μm). CBT70 (average particle size of 300 μm), CBT50 (average particle size of 150 μm), CBT71 (same as CBT70 except pigmented with a color).

While these silica particles have been included in surfactant containing compositions described in these two publications, their use in a liquid hand soap has not been described. An issue is created when trying to formulate a composition for use as a liquid hand soap because the silica acts as a thickening agent in the surfactant composition. Liquid hand soaps are dispensed from their containers by pumps. The viscosity of the composition has to allow for pumping of the composition so that the composition can be dispensed.

To regulate the viscosity of the silica particle composition, the inventors have discovered that the viscosity can be controlled by the addition of glycerin to the composition. In one embodiment, glycerin is present in the composition in an amount of at least 1% by weight. In another embodiment, glycerin is present in the composition in an amount of at least 2% by weight. In other embodiments, the amount is up to about 10% by weight of the composition. In other embodiments, the amount is about 2.5, about 3, about 4, about 5, about 6, or about 7% by weight. Additionally, the glycerin helps prevent clogging of pumps. Without the glycerin, the composition may dry in the pump and may clog the pump.

The silica particles are present in the composition in an amount that can initially be felt by hands when starting washing with the composition. In one embodiment, the amount of silica particles is about 0.05 to about 8% by weight of the composition. In other embodiments, the amount is 0.1% to about 5%.

In one embodiment, the silica particles have an initial average diameter of about 50 μm to about 600 μm. In other embodiments, the silica particle has an initial average diameter of about 180 to about 420 μm.

In an alternate exemplary embodiment of a cleansing soap composition, the silica particles further comprise color or pigment on the surface of the silica particles.

In other embodiments, the silica particle diminishes in size and cannot be felt by a user during washing before about 5 minutes, about 2 minutes, about 30 seconds, about 25 seconds, about 20 seconds, about 15 seconds, about 10 seconds, about 5 seconds, about 5 to about 30 seconds, or about 10 to about 30 seconds.

The composition includes a suspending agent that allows the silica particle to remain suspended. Suspending agents are any material that increases the ability of the composition to suspend material. Examples of suspending agents include, but are not limited to, synthetic structuring agents, polymeric gums, polysaccharides, pectin, alginate, arabinogalactan, carrageen, gellan gum, xanthum gum, guar gum, rhamsan gum, furcellaran gum, and other natural gum. A synthetic structuring agent in one embodiment is a polyacrylate. One acrylate aqueous solution used to form a stable suspension of the solid particles is manufactured by Lubrizol as CARBOPOL™ resins, also known as CARBOMER™, which are hydrophilic high molecular weight, crosslinked acrylic acid polymers. In one embodiment, the polymer is CARBOPOL™ Aqua SF-1. Other polymers that can be used include, but are not limited to, CARBOPOL™ Aqua 30, CARBOPOL™ 940 with a molecular weight of approximately 4,000,000, and CARBOPOL™ 934 with a molecular weight of approximately 3,000,000.

The suspending agents can be used alone or in combination. The amount of suspending agent can be any amount that provides for a desired level of suspending ability. In one embodiment, the suspending agent is present in an amount of about 0.01 to about 15% by weight of the composition. In other embodiments, the amount of suspending agent is about 1% to about 10%.

The composition contains at least one surfactant. The surfactant is used for cleansing. The surfactant may be one or more anionic surfactants, amphoteric surfactants, nonionic surfactants, cationic surfactants, and combinations thereof. Those of ordinary skill in the art will be aware of suitable surfactants and other additives readily identifiable from the International Cosmetic Ingredient Dictionary and Handbook, 10^{th} ed., (2004). Surfactants can be included in any desired amount. In one embodiment, surfactants are present in the composition in an amount of 0 to about 40% by weight. In one embodiment, the surfactants are present in an amount of about 1 to about 40% by weight. In one embodiment, surfactants are present in the composition in an amount of about 5 to about 40% by weight. In one embodiment, the surfactants are present in an amount of about 1 to about 10% by weight.

A variety of anionic surfactants can be utilized in the moisturizing body wash composition including, for example, long chain alkyl (C₆-C₂₂) materials such as long chain alkyl sulfates, long chain alkyl sulfonates, long chain alkyl phosphates, long chain alkyl ether sulfates, long chain alkyl alpha olefin sulfonates, long chain alkyl taurates, long chain alkyl isethionates (SCI), long chain alkyl glyceryl ether sulfonates (AGES), sulfosuccinates and the like. These anionic surfactants can be alkoxylated, for example, ethoxylated, although alkoxylation is not required. These surfactants are typically highly water soluble as their sodium, potassium, alkyl and ammonium or alkanol ammonium containing salt form and can provide high foaming cleansing power. Other equivalent anionic surfactants may be used. In one embodiment, the anionic surfactant comprises sodium laureth sulfate, sodium pareth sulfate, and combinations thereof. Anionic surfactants can be included in any desired amount. In one embodiment, anionic surfactants are present in the composition in an amount of 0 to about 15% by weight. In one embodiment, anionic surfactants are present in an amount of about 4 to about 12% by weight.

Amphoteric surfactants may also be included in the composition. These surfactants are typically characterized by a combination of high surfactant activity, lather forming and mildness. Amphoteric surfactants include, but are not limited to, derivatives of aliphatic secondary and tertiary amines in which the aliphatic radical can be straight chain or branched and wherein one of the aliphatic substituents contains about 8 to about 18 carbon atoms and one contains an anionic water solubilizing group, e.g., carboxy, sulfonate, sulfate, phosphate, or phosphonate. Examples of such compounds include sodium 3-dodecyaminopropionate, sodium 3-dodecylaminopropane sulfonate, N-alkyl taurines and N-higher alkyl aspartic acids. Other equivalent amphoteric surfactants may be used. Examples of amphoteric surfactants include, but are not limited to, a range of betaines including, for example, high alkyl betaines, such as coco dimethyl carboxymethyl betaine, lauryl dimethyl carboxy-methyl betaine, lauryl dimethyl alpha-carboxyethyl betaine, cetyl dimethyl carboxymethyl betaine, lauryl bis-(2-hydroxyethyl)carboxy methyl betaine, stearyl bis-(2-hydroxypropyl)carboxymethyl betaine, oleyl dimethyl gamma-carboxypropyl betaine, and lauryl bis-(2-hydroxypropyl)alpha-carboxyethyl betaine, sulfobetaines such as coco dimethyl sulfopropyl betaine, stearyl dimethyl sulfopropyl betaine, amido betaines, amidosulfobetaines and the like. Betaines having a long chain alkyl group, particularly coco, may be particularly useful as are those that include an amido groups such as the cocamidopropyl and cocoamidoethyl betaines. Amphoteric surfactants can be included in any desired amount. In one embodiment, amphoteric surfactants are present in the composition in an amount of 0 to about 15% by weight. In one embodiment, the amphoteric surfactants are present in the composition in an amount of about 1 to about 6% by weight.

Examples of nonionic surfactants include, but are not limited to, polysorbate 20, long chain alkyl glucosides having C₈-C₂₂ alkyl groups; coconut fatty acid monoethanolamides such as cocamide MEA; coconut fatty acid diethanolamides, fatty alcohol ethoxylates (alkylpolyethylene glycols); alkylphenol polyethylene glycols; alkyl mercaptan polyethylene glycols; fatty amine ethoxylates (alkylaminopolyethylene glycols); fatty acid ethoxylates (acylpolyethylene glycols); polypropylene glycol ethoxylates (for example the PLURONIC™ block copolymers commercially available from BASF); fatty acid alkylolamides, (fatty acid amide polyethylene glycols); N-alkyl-, N-alkoxypolyhydroxy fatty acid amides; sucrose esters; sorbitol esters; polyglycol ethers; and combinations thereof. Nonionic surfactants can be included in any desired amount. In one embodiment, nonionic surfactants are present in the composition in an amount of 0 to about 3% by weight. In one embodiment, nonionic surfactants are present in the composition in an amount of about 0.5 to about 1.5% by weight.

Cationic surfactants can also be included in the composition. Examples of cationic surfactants include, but are not limited to any quaternium or polyquarternium compound. Cationic surfactants can be included at any desired level. In one embodiment, cationic surfactants are present in the composition in an amount of 0 to about 2% by weight. In one embodiment, cationic surfactants are present in the composition in an amount of about 0.1 to about 0.3% by weight.

Many additional surfactants are described in McCUTCHEON'S DETERGENTS AND EMULSIFIERS (1989) and other reference materials that are well known to those of ordinary skill in the art.

In one embodiment, the surfactant is a combination of an anionic surfactant and an amphoteric surfactant. In one embodiment, the surfactant comprises a C10-C16 alcohol ethoxylate and cocoamidopropyl betaine. In one embodiment, the alcohol ethoxylate is sodium C10-C16 alcohol ethoxylate.

In other embodiments, the composition can contain additional particulate materials. An example of a particulate material is shea butter beads, such as Butyrospermum Parkii beads from ISP Corp. available as CAPTIVATES™ 2485.

In some embodiments, the composition has Brookfield viscosity of about 3500 to about 35,000 mPas (cps). In one embodiment, the viscosity is less than about 14,000 mPas (cps) so that it is pumpable. In other embodiments, the viscosity is about 4000 to about 14,000 mPas (cps). Brookfield viscosity is measured on a DVII viscometer with spindle 5 at 20 rpm. In some embodiments the composition has a yield of about 4 to about 28. In other embodiments, the yield is about 8 to about 15. The yield is measured on a AR-1000 from TA instruments.

To mix the silica into the composition, the silica is first prepared in a bead slurry and then added to the remainder of the composition (the base). This allows for easier processing. The base is the surfactant, the suspending agent, and any additional glycerin. The bead slurry is 35 weight % structured base, 25 weight % silica, and 40 weight % glycerin. The glycerin is added to the structured base and mixed thoroughly. Silica beads are then added to the solution very slowly while mixing at low speed until fully and equally dispersed. The amount of slurry added to the base is determined based on the amount of silica desired in the final composition. The amount of structured base and glycerin that are not part of the slurry are adjusted to achieve the desired amount in the final composition.

In one embodiment, the stability of the bead slurry and the composition are measured. For the bead slurry, in one embodiment, it is desired that the bead slurry be stable for 1 to 2 weeks at 49° C., and in another embodiment, up to 4 weeks at 25° C. The stability is determined by visual inspection of the material at the end of 1 week, 2 weeks, or 4 weeks to see if there is any phase separation. Also, the viscosity, color, pH, and odor are evaluated. In one embodiment, it is desired that the viscosity remain below 13,000 mPas (cps), the pH is 6 to 8 with a target of 6.7, no yellowing of the composition, and no bleeding of color from any shea butter beads that may be included.

For the composition, stability is determined over a 13 week period at 49° C., 40° C., 25° C., and 10° C. Samples at each temperature are evaluated at the end of 4 weeks, 8 weeks, and 13 weeks to see if there is any phase separation. In one embodiment, it is desired that the viscosity be 3,000 to 10,000 mPas (cps), the pH is 6 to 8 with a target of 6.7, no yellowing of the composition, and no bleeding of color from any shea butter beads that may be included.

Additionally, the composition can be measured for freeze-thaw stability. The composition is placed into a −10° C. freezer for 24 hours. It is removed and stored at room temperature until it reaches 25° C. The composition repeats this process for 2 more cycles for a total of 3 freeze-thaw cycles.

In another embodiment, a method comprising:

a) applying the composition to hands;
b) rubbing the hands together until a sensory change detectable to the hands is perceived; and
c) rinsing the hands with water.

The sensory change silica particle indicator of the composition of this invention is suitable for addition to materials such as toiletries including but are not limited to soaps (liquid and bar), shampoos, and bodywash. The present invention may be used in a number of settings including, but not limited to, private homes, hospitals, work places, childcare centers, nursing homes, schools, restaurants, airports, and food-preparation and food-processing establishments and the like.

### EXAMPLES

Exemplary embodiments of the present invention will be illustrated by reference to the following examples, which are included to exemplify, but not limit the scope of the present invention.

In the examples and elsewhere in the description of the invention, chemical symbols and terminology have their usual and customary meanings. Temperatures are in degrees Celsius unless otherwise indicated. The amounts of the components are in weight percents based on the standard described; if no other standard is described then the total weight of the composition is to be inferred. Various names of chemical components include those listed in the CTFA International Cosmetic Ingredient Dictionary (Cosmetics, Toiletry and Fragrance Association, Inc., 7^{th} ed. 1997).

The silica particles used are the ones available from INEOS Silicas described above.

Table 1 illustrates the composition of the structured base used in the examples. The amounts in the table and examples below are for the amounts as supplied for the materials.

TABLE 1
Structured Base Formula

| | Weight |
|---|---|
| Sample | Percent |
| Demineralized water | 46.899 |
| SO₃ Na Pareth 145-2EO Sulfate Base-25.5% | 37.137 |
| CARBOPOL ™ Aqua SF-1 Polymer (Lubrizol) | 8.95 |
| Cocoamidopropyl Betaine | 5.64 |
| Membrane cell caustic- 38.3% Na₂O | 0.74 |
| DMDM Hydantoin | 0.42 |
| Tetrasodium EDTA-39% solution | 0.21 |

The following compositions were prepared. The compositions are based on the final composition.

| | Formulation | | | | |
|---|---|---|---|---|---|
| | A | B | C | D | E |
| Structured Base from Table 1 | QS | QS | QS | QS | QS |
| 99.0%-101.0% Glycerin - USP | 4.00 | 3.00 | 4.00 | 4.00 | 4.00 |
| Perfume | 0.35 | 0.35 | 0.35 | 0.35 | 0.35 |
| Amorphous silica (CBT60) from Ineos | 0.70 | 0.70 | 1.00 | 2.00 | 4.00 |
| DI water | 1.40 | 1.40 | 1.40 | 1.40 | 1.40 |
| DMDM Hydantoin | 0.0056 | 0.0056 | 0.0056 | 0.0056 | 0.0056 |
| FD&C Red 40 | 0.00025 | 0.00025 | 0.00025 | 0.00025 | 0.00025 |
| FD&C Yellow 5 | 0.00055 | 0.00055 | 0.00055 | 0.00055 | 0.00055 |
| Citric Acid - 50% solution | 0.01 | 0.01 | 0.01 | 0.01 | 0.01 |
| Table salt solution 25% | 0.01 | 0.01 | 0.01 | 0.01 | 0.01 |
| Total | 100 | 100 | 100 | 100 | 100 |
| Viscosity mPas (cps) | 4720 | | 4980 | | |

Procedure for addition of silica and glycerin to structured base: Glycerin is added to structured base (except the part for the slurry) and mixed at room temperature for approximately 10 minutes. Fragrance was added to the solution and mixed for 30 minutes at room temperature. After the fragrance was fully mixed in, the bead slurry described below was added and mixed at low speed as to not break the beads. Viscosity and pH were measured and adjusted with NaCl or citric acid as needed.

Bead Slurry: To mix in a liquid composition to the base rather than the dry silica, a bead slurry is prepared. The slurry is 35 weight % structured base, 25 weight % silica, and 40 weight % glycerin. The glycerin is added to the structured base and mixed thoroughly. Silica beads are then added to the solution very slowly while mixing at low speed until fully and equally dispersed. The amount of slurry added to the base is determined based on the amount of silica desired in the final composition. The amount of structured base and glycerin that are not part of the slurry are adjusted to achieve the desired amount in the final composition.

The table below is based on the average of 2 to 5 people testing the compositions. The compositions were prepared using Formula C above and adjusting the type and amount of silica. The table shows the amount of time for a person to notice a perceivable change.

| Silica particle | Concentration | Time of wash (s) | |
|---|---|---|---|
| CBT50 | 1% | <15 | seconds |
| CBT50 | 3% | ca. 15 | seconds |
| CBT50 | 4% | 20-25 | seconds |
| CBT50 | 5% | 20-25 | seconds |
| CBT50 | 7% | >30 | seconds |
| CBT70 | 0.7% | >20 | seconds |
| CBT70 | 1% | >30 | seconds |
| CBT70 | 3% | >1 | minute |
| CBT60 S | 1% | <10 | seconds |
| CBT60 S | 1.5% | 15-20 | seconds |
| CBT60 S | 2% | 15-20 | seconds |
| CBT60 S | 3% | >25 | seconds |
| CBT60 S | 4% | >30 | seconds |
| CBT60 S | 5% | >40 | seconds |
| SD4354 | 0.5% | <15 | seconds |
| SD4354 | 0.7% | 15-20 | seconds |
| SD4354 | 1% | 15-20 | seconds |
| SD4354 | 1.5% | >40 | seconds |
| SD4355 | 0.5% | 15-20 | seconds |
| SD4355 | 0.7% | >30 | seconds |
| SD4355 | 1% | >40 | seconds |

Examples 1 and 2 below show bead slurry compositions that are added to Formula C above. The viscosity and stability of the final composition are given. It is desired to have the viscosity of the final composition less than 14,000 mPas (cps) for ease of manufacture.

### Example 1

| | | | | |
|---|---|---|---|---|
| % base | 40 | 35 | 30 | 25 |
| % CBT60 (silica) | 25 | 25 | 25 | 25 |
| % glycerin | 35 | 40 | 45 | 50 |
| Viscosity mPas (cps) | 16400 | 12860 | 10220 | 2700 |
| Stability | Stable | Stable | Not | Not |
| | | | stable | Stable |

### Example 2

| | | | |
|---|---|---|---|
| % base | 80 | 51 | 37 |
| % CBT70 (silica) | 20 | 20 | 20 |
| % glycerin | 0 | 29 | 43 |
| viscosity | 45,600 | 13,600 | 6,700 |
| | Stable | Stable | Un-stable |

The formulations below are prepared to show the effect of glycerin on the composition for pump clogging.

Formulation 1 Contains:

| | |
|---|---|
| structured base | 93.9% |
| Euperlan ™ PK3000AM pearlescent agent from Cognis | 2% |
| Color Premix | 0.3374% |
| Fragrance | 0.35% |
| Silica (CBT60 or 70) | 1% |
| NaCl (25% soln) | 0.1% |
| Shea butter beads | 0.25% |
| Water | 2.09% |

Formulation 2 Contains:

| | |
|---|---|
| structured base | 92.9% |
| Euperlan ™ PK3000AM pearlescent agent from Cognis | 2% |
| Glucam ™ mixture of (weight %) | 1% |
| 35.7143% PPG-10 | |
| 35.7143 PEG-10 | |
| 28.1714 Water | |
| 0.4 DMDM Hydantoin | |
| Color Premix | 0.3374% |
| Fragrance | 0.35% |
| Silica (CBT60 or 70) | 1% |
| NaCl (25% solution) | 0.1% |
| Shea butter beads | 0.25% |
| Water | 2.09% |

Formulation 3 Contains:

| | |
|---|---|
| structured base | 91.25% |
| Euperlan ™ PK3000AM pearlescent agent from Cognis | 2% |
| Color premix | 0.3374% |
| Fragrance | 0.35% |
| Silica (CBT60 or 70) | 1% |
| Glycerin | 4% |
| NaCl (25% solution) | 0.1%% |
| Shea butter beads | 0.25% |
| Water | 0.71% |

The formulations are placed in a commercially available Softsoap™ liquid hand soap dispenser available from Colgate-Palmolive Company. Clogging is qualified by visual observation of the pump, but it is not quantified. The pump is observed to determine if the pump requires more force to pump or if there is caking of material on the pump. Pumping can be observed in three different settings: (1) pumping twice per day, (2) pumping three times per week, and (3) pumping once per week. The pumping was compared to the dispensing of the commercially available Softsoap™ liquid hand soap.

Formulas 1 and 2 caused clogging in the pump. Formula 3 with the glycerin did not have clogging. Formula 3 dispensed comparably to the Softsoap™ liquid hand soap. The addition of the glycerin allowed for a dispensable product.

What is claimed is:

1. A composition comprising:
a) a surfactant,
b) a suspending agent,
c) glycerin, and
d) a silica particle that disintegrates during use.

2. The composition of claim 1, wherein the glycerin is present in an amount of at least 2% by weight.

3. The composition of claim 1, wherein the silica particle has an average diameter of about 50 μm to about 600 μm.

4. The composition of claim 1, wherein the silica particle size diminishes in size and cannot be felt by a user during hand washing at a time occurring before 2 minutes.

5. The composition of claim 1, wherein the silica particle size diminishes in size and cannot be felt by a user during hand washing at a time occurring before about 30 seconds.

6. The composition of claim 1, wherein the silica particle diminishes in size and cannot be felt by a user at a time between about 10 to about 30 seconds.

7. The composition of claim 1, wherein the silica particle is present in an amount of about 0.05 to about 8 weight % of the composition.

8. The composition of claim 1, wherein the glycerin is present in an amount of 2 to about 10 weight % of the composition.

9. The composition of claim 1, wherein the suspending agent is present in an amount of about 0.01 to about 15 weight % of the composition.

10. The composition of claim 1, wherein the surfactant is present in an amount of greater than 0 to about 20 weight % of the composition.

11. The composition of claim 1, wherein the surfactant comprises a C10-C16 alcohol ethoxylate and cocoamidopropyl betaine.

12. A method comprising:
a) applying the composition of claim 1 to hands;
b) rubbing the hands together until a sensory change detectable to the hands is perceived; and
c) rinsing the hands with water.

13. The method of claim 12, wherein the sensory change is felt before about 2 minutes.

14. The method of claim 12, wherein the sensory change is felt before about 30 seconds.

15. The method of claim 12, wherein the sensory change is felt at a time between about 10 to about 30 seconds.
